(19) United States
(12) Patent Application Publication
(10) Pub. No.: US 2009/0005888 A1
(43) Pub. Date: Jan. 1, 2009

(54) Configurable advanced process control

(76) Inventors: Nital S. Patel, Mesa, AZ (US); Xian Luo, Gilbert, AZ (US)

Correspondence Address: INTEL CORPORATION;c/o INTELLEVATE, LLC, P.O. BOX 52050, MINNEAPOLIS, MN, 55402, US

(21) Appl. No.: 11/824,237

(22) Filed: Jun. 29, 2007

(51) Int. Cl. G05B 13/02

(52) U.S. Cl. 700/44

(57) ABSTRACT

Systems and methods associated with configurable advanced process control (APC) application development are described. One embodiment includes a computing system that includes configuration files corresponding to APC clients. The computing system also includes computational models corresponding to the configuration files. The computing system also includes a Rapid Advanced Control Enabler (RACE). A RACE may select a configuration file to process based, at least in part, on a request received from an APC client. A RACE may also dynamically load a computational model that corresponds to the selected configuration file. A RACE may also execute the dynamically loaded computational model and provide a response to the APC client from which the request was received.

### TECHNICAL FIELD

Example systems and methods relate to the field of advanced process control (APC). More particularly, example systems and methods concern a framework that facilitates developing, deploying, and using APC applications.

### BACKGROUND

Semiconductor fabrication requires high levels of precision. Variations in semiconductor fabrication processes may yield sub-optimal process performance. Advanced Process Control (APC) applications are used to control semiconductor fabrication. APC applications may help improve semiconductor fabrication performance by, for example, reducing variations in fabrication processes. An APC application may implement an APC controller in, for example, computer hardware and/or software.

Conventionally, APC controllers have been individually written, individually stored, individually invoked, and so on. In some examples, APC controllers have been written as Visual Basic Script (VBScript) programs or in other scripting languages. A separate VBScript program may have been written for each APC controller. Additionally, a unique computational model may have been associated with each APC controller script. To execute a computational model, an APC controller may have been invoked on a transaction-to-transaction basis. The transaction may have corresponded to APC client requests.

The process of creating each individual APC application may have been tedious and inefficient, leading to lengthy development times and lengthy test times. These lengthy development and test times may in turn have resulted in long delivery times.

### BRIEF DESCRIPTION OF THE DRAWINGS

The accompanying drawings, which are incorporated in and constitute a part of the specification, illustrate various example systems, methods, and other embodiments of various aspects of the invention. It will be appreciated that the illustrated element boundaries (e.g., boxes, groups of boxes, or other shapes) in the figures represent one example of the boundaries. One of ordinary skill in the art will appreciate that in some embodiments one element may be designed as multiple elements, multiple elements may be designed as one element, an element shown as an internal component of another element may be implemented as an external component and vice versa, and so on. Furthermore, elements may not be drawn to scale.

FIG. 1 illustrates a conventional system employing a conventional APC controller.

FIG. 2 illustrates an example APC application that can be executed on an example common core.

FIG. 3 illustrates an example of components of a Rapid Advanced Control Enabler (RACE) common core.

FIG. 4 illustrates an example system associated with APC application development, deployment, and use.

### DETAILED DESCRIPTION

Example systems and methods facilitate developing, deploying, and using APC applications. Developing and deploying APC applications is facilitated by pairing a computational model with a configuration file and then using a common core to process both. While an APC application is described, one skilled in the art will appreciate that example systems and methods may also be employed with APC services. Example systems and methods may employ a universal controller interface between the computational model and the configuration file. The behavior and actions of the universal controller may be controlled based, at least in part, on the configuration file in the pair. Therefore, one common controller can execute multiple computational models based on control associated with the configuration file. Consider a first semiconductor fabrication process (e.g., epi-undercut) and a second semiconductor fabrication process (e.g., thin film). An example common controller may run a first computational model to implement an etch depth controller at a first time and then may run a second computational model to implement a deposition thickness controller. Controller behavior with respect to the two computational models may be dictated by the configuration files. Thus, data and processes associated with each APC controller may be classified, categorized, and stored in the configuration files rather than being embedded in individually written code specific to the controller.

Being able to use a single controller for different models and different processes facilitates reducing and/or eliminating software development (e.g., VBScript coding) typical in conventional APC application development. Using a single controller may also facilitate improving semiconductor fabrication efficiency through improved data sharing. Traditional semiconductor fabrication has relied on statistical process control to attempt to achieve high levels of precision and accuracy. Yet the statistics may have been handled individually by disparate VBScripts. Example systems and methods facilitate using statistical process control (SPC) and APC and sharing data associated with those processes for run-to-run, wafer-to-wafer, within-wafer, and other fabrication processes. Thus, example systems and methods rely on classifying model and controller parameters into well-defined categories.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

The following includes definitions of selected terms employed herein. The definitions include various examples and/or forms of components that fall within the scope of a term and that may be used for implementation. The examples are not intended to be limiting. Both singular and plural forms of terms may be within the definitions.

“Computer communication”, as used herein, refers to a communication between computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Machine-readable medium”, as used herein, refers to a medium that participates in directly or indirectly providing signals, instructions and/or data that can be read by a machine (e.g., computer). A machine-readable medium may take forms, including, but not limited to, non-volatile media (e.g., optical disk, magnetic disk), and volatile media (e.g., semiconductor memory, dynamic memory). Common forms of machine-readable mediums include floppy disks, hard disks, magnetic tapes, RAM (Random Access Memory), ROM (Read Only Memory), CD-ROM (Compact Disk ROM), and so on.

In some examples, “database” is used to refer to a table. In other examples, “database” may be used to refer to a set of tables. In still other examples, “database” may refer to a set of data stores and methods for accessing and/or manipulating those data stores.

“Data store”, as used herein, refers to a physical and/or logical entity that can store data. A data store may be, for example, a database, a table, a file, a list, a queue, a heap, a memory, a register, a disk, and so on. In different examples a data store may reside in one logical and/or physical entity and/or may be distributed between multiple logical and/or physical entities.

“Logic”, as used herein, includes but is not limited to hardware, firmware, software in execution, and/or combinations thereof to perform a function(s) or an action(s), and/or to cause a function or action from another logic, method, and/or system. Logic may include a software controlled microprocessor, discrete logic (e.g., application specific integrated circuit (ASIC)), an analog circuit, a digital circuit, a programmed logic device, a memory device containing instructions, and so on. Logic may include a gate(s), a combinations of gates, other circuit components, and so on. Where multiple logical logics are described, it may be possible in some examples to incorporate the multiple logical logics into one physical logic. Similarly, where a single logical logic is described, it may be possible in some examples to distribute that single logical logic between multiple physical logics.

“Signal”, as used herein, includes but is not limited to, electrical signals, optical signals, analog signals, digital signals, data, computer instructions, processor instructions, messages, a bit, a bit stream, or other means that can be received, transmitted and/or detected.

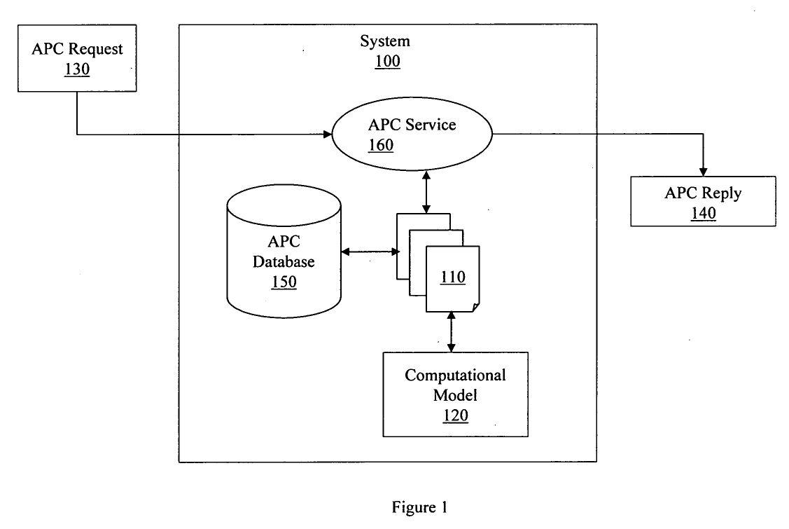

FIG. 1 illustrates a conventional system 100 that uses APC controllers written individually as, for example, VBScript programs. An APC service 160 may execute using a controller 110 that has interacted with both a computational model 120 and an APC database 150. There may be a one to one relationship between a controller 110 and a computational model 120. Data for controller 110 may be retrieved from APC database 150. A controller 110 may be invoked on a transaction-to-transaction basis in response to an APC request 130. After the APC service 160 executes, an APC reply 140 may be provided. The APC controllers written as VBScripts may each have been individual works of art that added little, if anything, to the body of shared knowledge associated with improving fabrication.

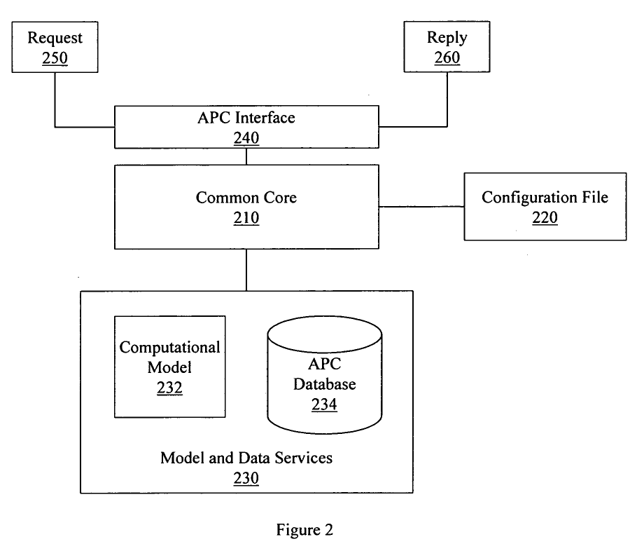

FIG. 2 illustrates a common core 210 for use with an APC application(s) and/or service(s). Common core 210 may be, for example, a computer component. Instead of having a set of APC applications written as VBScripts, an APC application can be reduced to a schema based configuration file 220 that can be processed by common core 210. In one example, the schema based configuration file 220 may be an XML (Extensible Markup Language) file. This approach to APC application development may reduce development and test time by allowing application developers to focus on modeling APC data and binding the data model to a computational model 232 using schema based configuration file 220. Memorializing process information in a human readable XML file may facilitate sharing that information with other developers and/or APC applications.

Common core 210 interacts with APC interface 240 and model and data services 230. A request 250 to perform an APC action may be received by APC interface 240. A reply 260 including the results of the APC action may be sent by APC interface 240. Request 250 and/or reply 260 may be delivered by computer communications. The request 250 may be received, for example, from a station controller, or from an APC client(s). A station controller may be used for monitoring and automating semiconductor fabrication. A station controller may send APC requests to an APC execution engine and may process replies from an APC execution engine. Another APC client may be, for example, an SPC client that publishes measurement data to the common core 210. These request sources may send requests to have a certain APC application or service performed. For example, a client may want to control a semiconductor fabrication process (e.g., epi-undercut, thin film deposition). The APC interface 240 routes the request 250 to the common core 210 for processing, and can support multiple communication protocols available to the clients.

Coupling between the common core 210 and a computational model 232 may be achieved through information stored in a configuration file 220. A configuration file 220 may be selected by the common core 210 based on information associated with the request 250. Recall that example systems and methods pair a computational model with a configuration file. Thus, a computational model 232 that is paired with a configuration file 220 may be dynamically loaded from a model and data services provider 230 and executed by common core 210.

Common core 210 may be a COM+ (component object model plus) application. While a COM+ application is described, it is to be appreciated that COM+ is just one example application and that others may be employed. When common core 210 is a COM+ application, computational model 232 may be a COM (component object model) component. Once again the COM+ and COM embodiments represent one example and other examples may be employed. The computational model 232 may be written using languages or packages that support COM. In one example, computational model 232 is a COM component written and compiled using Matlab.

Model and data services provider 230 may also include an APC database 234 that includes standardized table schemas for storing data models. These standardized database table schemas may be used across APC applications, which facilitates application developers focusing on data modeling for process control. As a result, APC application development as well as semiconductor fabrication may be more efficient through visible sharing.

Process variations are undesirable and yet practically inevitable given the fact that fabrication occurs at different times in different chambers using degradable components (e.g., polisher). Sharing information between chambers or similar tools may facilitate reducing variations. Example systems and methods rely on classifying model and controller parameters into well-defined categories. This classification facilitates designing, implementing, and deploying APC applications and/or services, which may in turn facilitate sharing information and thus reducing variations. Process variations may arise from tool-state and/or wafer-state related process inputs. The classification of parameters facilitates understanding and using data that may facilitate reacting to process variations.

In one example, model and controller parameters are classified into categories including feed-forward data, context data, setting data, and measurement data. The feed-forward data may be received, for example, from a station controller. The feed-forward data may include, for example, wafer indices, wafer counts, lot history data, and so on. The context data may include, for example, machine data, product data, route data, process operation data, lot identification data, and so on. The setting data, which may also be referred to as monitor data, may include lot settings, wafer level settings, lot monitors, wafer level monitors, and so on. The measurement data may include process data, metrology data, SPC data, and so on. This data may include site level data, wafer level data, lot level data, and so on. The model and controller parameters and their classification may facilitate defining variables in an APC application along with their roles, associated data integrity rules, and so on. This in turn may facilitate implementing category specific business rules.

The following sample XML code illustrates a “Setting” definition associated with model and controller parameters classification. This definition is an example of data classification that may facilitate more rapid APC application development and deployment.

```
<Setting Name=”WaferEtchTimes” Type=double[ ]”>
    <UpperWarnLimit>55</UpperWarnLimit>
    <LowerWarnLimit>35</LowerWarnLimit>
    <UpperErrorLimit>60</UpperErrorLimit>
    <LowerErrorLimit>30</LowerErrorLimit>
    <Precision>1</Precision>
    <Deadband>0</Deadband>
    <MaxMoveWarn>5</MaxMoveWarn>
    <MaxMoveError>7</MaxMoveError>
    <OnMaxMove>Clamp</OnMaxMove>
    <MaxRange>15</MaxRange>
    <SettingGroup>EUCAPC</SettingGroup>
    <Level>Wafer</Level>
    <IndexBy>SlotID</IndexBy>
    <Unit>sec</Unit>
</Setting>
```

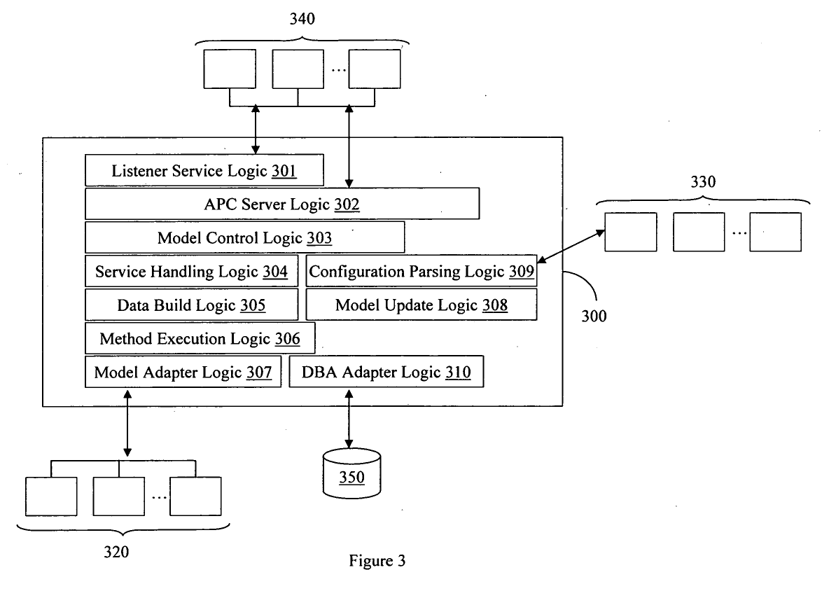

FIG. 3 illustrates one example of the components of a Rapid Advanced Control Enabler (RACE) common core 300. Listener service logic 301 may format published data received from clients 340 (e.g., statistical process control clients) into valid APC requests. Application specific XSLT (extensible style-sheet language transformation) files may be used for formatting the received published data. APC server logic 302 may inspect incoming APC requests and execute a model control logic 303, which may in turn invoke an independent service handling logic 304 for different job types or services. Service handling logic 304 may control the data automation of the transaction. Data build logic 305 may be a sub-class for job types or services to provide specialized data handling as needed. For example, data build logic 305 may initialize data, build inputs to the method execution logic 306, provide database update services, and so on.

Method execution logic 306 may manage execution of computational models 320 and input/output processing. Model adapter logic 307 may provide an interface to computational models 320. Model update logic 308 may manage updates of states of the computational models 320. Configuration parsing logic 309 may accept configuration files 330 and produce manageable classes. Database administration (DBA) adapter logic 310 may interface with an APC database 350 and handle physical table layout translation and SQL queries. While FIG. 3 illustrates one arrangement of logics for an example RACE, it is to be appreciated that other logics and computer components may be arranged in different configurations in accordance with different embodiments of the invention.

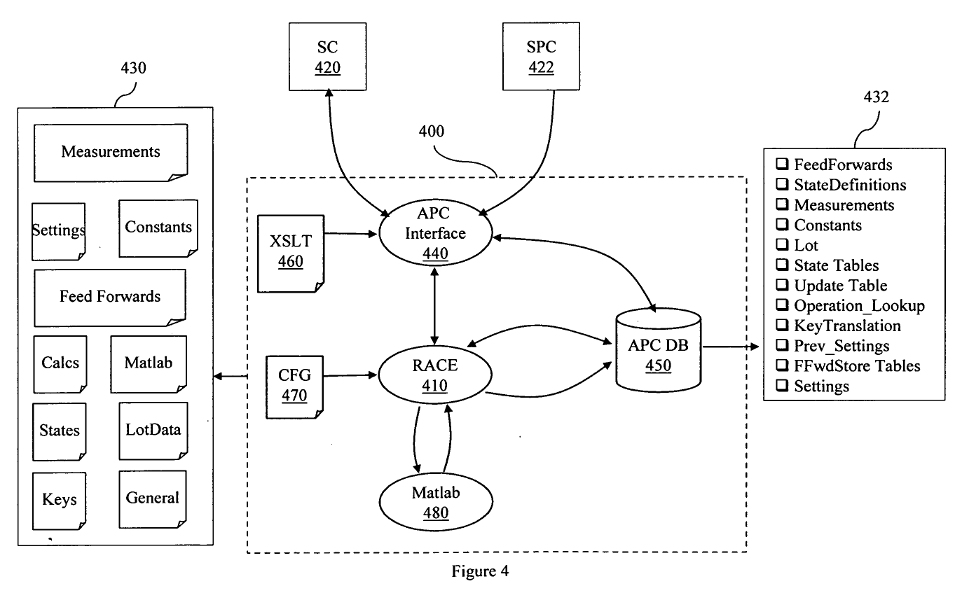

FIG. 4 illustrates a system 400 for producing and using APC controllers with a RACE common core. System 400 includes a RACE 410. System 400 interacts with a station controller (SC) 420 and an SPC 422. For example, system 400 may receive an APC request from station controller 420 and may communicate data including context data, feed forwards, measurements, and so on. System 400 may also have data published to it from SPC 422. This data may include context data, measurements, and so on. Data published by the SPC 422 may be transformed according to an XSLT 460.

System 400 may produce and/or interact with a set of configuration files 430 and a set of RACE database tables 432. These files and tables may be produced through the combined efforts of RACE 410, APC interface 440, APC database 450, a computational model 460, and a user/designer. The files and tables may be written to a machine-readable medium. It is to be appreciated that the data in database tables 432 is related to the configuration data in the configuration files 432. For example, data from configuration files 432 may be used to generate data in database tables 432.

The APC interface 440 may receive data from SC 420 and/or SPC 422. The APC interface 440 may also receive an APC request from SC 420. The APC Interface 440 may receive a script table from APC database 450. The APC database may also provide data definitions, state, processing context, and so on to RACE 410. The APC Interface 440 may provide a request to RACE 410 and may receive a reply from RACE 410. Upon receiving the request, RACE 410 may provide input data values to computational model 460 and may receive settings, states, monitor data, and so on, in return. RACE 410 may update lot and state tables in APC database 450. RACE 410 will interact with a configuration file 470 stored with the set of configuration files 430. APC database 450 may store information in the set of race database tables 432. System 400 may provide an APC reply to, for example, SC 420.

To deploy an APC application associated with system 400, configuration files 430 and computational models 460 may be transferred to an APC application server. Once deployed, the APC application may be executed by sending a request from an APC client to system 400. One example RACE will intercept APC requests from an NTSC or an SPC. The example RACE will provide application level data automation. The example RACE will also provide dynamic method selection and execution of a computational model based on an XML configuration file.

RACE enabled applications are to share certain characteristics. For example, RACE enabled applications are to have well-defined categories of APC data. This may force APC developers to preplan data into defined categories (e.g., states, constants, feed-forwards, settings, measurements, calculated values, monitors). RACE enabled applications will exhibit data transparency via standardized XML configuration. Thus, application data will be described in a human-readable XML configuration file. This may in turn increase understanding the application which will facilitate its support and troubleshooting. RACE enabled applications will interact with standardized APC table definitions. RACE enabled applications may rely on abstracted computation models, which may be coded using languages or packages that facilitate data modeling and computations (e.g., Matlab).

A RACE may be organized in a layered architecture and may interact with several components. For example, a RACE may interact with an SC client and/or an SPC client. An SC client may be, for example, a station controller that sends APC requests and processes replies. An SPC client may be, for example, a statistical process control that publishes measurement data to an APC application. The published data are intercepted and translated into valid APC requests by listener services.

What is claimed is:

1. A system, comprising:
one or more configuration files corresponding to one or more advanced process control applications;
one or more computational models corresponding to the one or more configuration files; and
a common core to:
select a configuration file based, at least in part, on a request received from an advanced process control (APC) client;
dynamically load a computational model corresponding to the selected configuration file;
execute the dynamically loaded computational model; and
provide a signal to the APC client from which the request was received.

2. The system of claim 1, the common core being a COM+ (component object model plus) application.

3. The system of claim 2, the one or more computational models being COM (component object model) components.

4. The system of claim 1, the one or more configuration files being XML (extensible markup language) files.

5. The system of claim 4, where a configuration file classifies into one or more categories one or more of, a set of model parameters, and a set of controller parameters, the one or more categories including, feed-forward data, context data, setting data, and measurement data.

6. The system of claim 5, where the feed-forward data includes one or more of, the entity state, or a lot history data.

7. The system of claim 6, where the context data includes data describing a process and a material characteristic relevant to a current transaction.

8. The system of claim 7, where the setting data includes recommended APC settings for process control.

9. The system of claim 1, the APC client being a station controller associated with automated semiconductor fabrication.

10. The system of claim 1, the APC client being a statistical process control client associated with automated semiconductor fabrication.

11. The system of claim 1, the common core being a Rapid Advanced Control Enabler (RACE), the RACE comprising:
a listener service logic to format the request received from the APC client;
a service handling logic to control data automation;
a model control logic to invoke the service handling logic;
an APC server to inspect the APC request and to execute the model control logic;
a data build logic to provide a data handling service;
a method execution logic to manage execution of the computational model and to manage input and output processing;
a model adapter logic to provide an interface to the computational model;
a model update logic to manage updates of computational model states;
a configuration parsing logic to process configuration files into manageable classes; and
a database adapter logic to translate a table layout.

12. A method for developing an APC application, comprising:
generating a computational model corresponding to an APC application, where the computational model is configured to be executed by a common core;
generating a configuration file corresponding to the computational model;
generating a data table definition based, at least in part, on the configuration file;
generating one or more data files based, at least in part, on the configuration file; and
storing one or more of the computational model, the configuration file, the data table definition, and the data files in a data store.

13. The method of claim 12, the computational model being a COM component.

14. The method of claim 12, the data table definitions and the one or more data files being generated by a Rapid Advanced Control Enabler (RACE) object builder.

15. The method of claim 12, the computational model corresponding to an APC controller or APC application for controlling a semiconductor fabrication process.
